(19) United States
(12) Patent Application Publication
(10) Pub. No.: US 2014/0019539 A1
(43) Pub. Date: Jan. 16, 2014

(54) DETERMINATION OF INFLUENCE SCORES

(71) Applicants: Ashley B. Novak, Chicago, IL (US); Crysta J. Metcalf, Cary, IL (US); Nitya Narasimhan, Hopewell Junction, NY (US)

(72) Inventors: Ashley B. Novak, Chicago, IL (US); Crysta J. Metcalf, Cary, IL (US); Nitya Narasimhan, Hopewell Junction, NY (US)

(73) Assignee: GENERAL INSTRUMENT CORPORATION, Horsham, PA (US)

(21) Appl. No.: 13/549,580

(22) Filed: Jul. 16, 2012

(51) Int. Cl. G06F 15/16

(52) U.S. Cl. 709/204

(57) ABSTRACT

Disclosed are methods and apparatus for determining an influence score for a user of one or more social-networking services. The methods comprise acquiring a set of one or more criteria, the criteria having been specified by a first party, acquiring a dataset comprising information that relates to the user's interactions with one or more of the social networks provided by one or more of the social-networking services, selecting from the dataset data that are in accordance with the one or more criteria, and determining some function of the selected data, thereby providing the influence score for the second party.

### FIELD OF THE INVENTION

The present invention is related generally to determining influence scores of users of social-networking services.

### BACKGROUND OF THE INVENTION

Social-networking services (e.g., Google+™, Facebook™, Twitter™, etc.) are increasingly being used by people to discover multimedia content or other information that is useful or relevant to them. Social-networking websites may also be used by people to prioritize this information.

For example, users of a social-networking website may discover information directly from a source (e.g., by “following” people they know, companies they like, or authorities they trust) or indirectly via other users (e.g., peer users) of the social-networking website (e.g., by viewing information shared, recommended, or commented on by those other users).

There exist a number of user ranking systems, such as Klout™ and Peerindex™. Such systems typically analyze social-networking website data to calculate “influence scores” for users of those social-networking websites. Such systems may also determine an “influence profile” that provides additional insights or metrics (e.g., reach, authoritative topics, engagement, etc.) about users.

These known ranking systems tend to rely on machine-driven analysis of the social-networking website data.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic illustration (not to scale) showing an example system;

FIG. 2 is a schematic illustration (not to scale) of a server of the example system;

FIG. 3 is a schematic illustration (not to scale) of the first user device of the example system; and

FIG. 4 is a process flow chart showing certain steps of a process of determining an influence score for a user of one or more social-networking websites.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

Apparatus for implementing any of the below described arrangements, and for performing the method steps described below, may be provided by configuring or adapting any suitable apparatus, for example one or more computers or other processing apparatus or processors, or by providing additional modules. The apparatus may comprise a computer, a network of computers, or one or more processors, for implementing instructions and using data, including instructions and data in the form of a computer program or plurality of computer programs stored in or on a machine-readable storage medium such as computer memory, a computer disk, ROM, PROM etc., or any combination of these or other storage media.

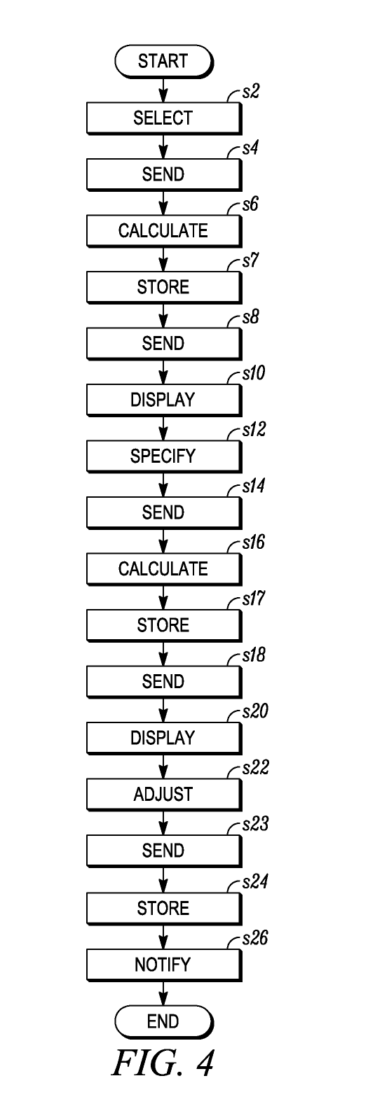

It should be noted that certain of the process steps depicted in the flowchart of FIG. 4 and described below may be omitted or such process steps may be performed in an order differing from that presented below and shown in FIG. 4. Furthermore, although all the process steps have, for convenience and ease of understanding, been depicted as discrete temporally-sequential steps, nevertheless some of the process steps may in fact be performed simultaneously or at least overlapping to some extent temporally.

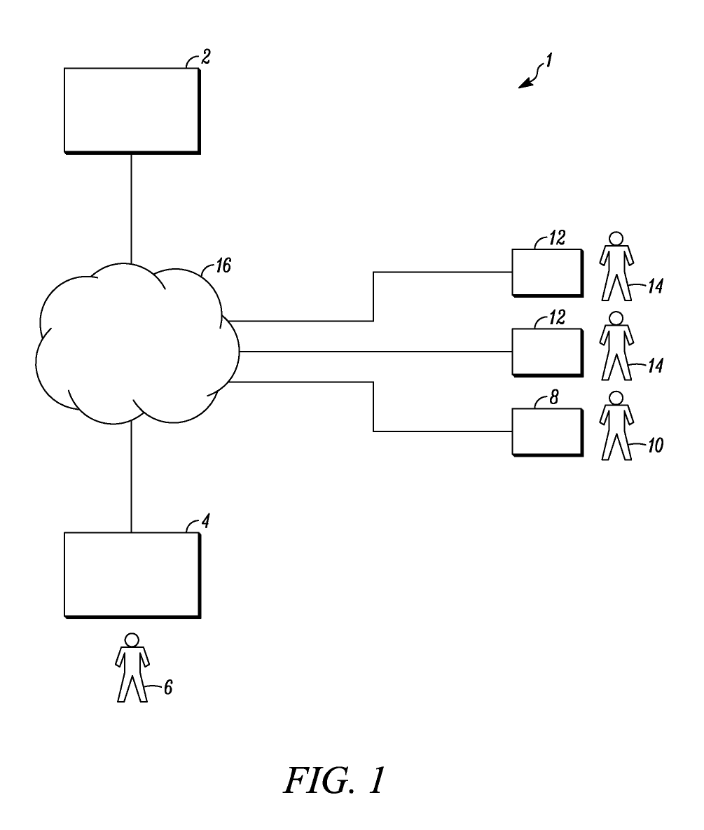

Referring now to the Figures, FIG. 1 is a schematic illustration (not to scale) showing an example system 1 in which an embodiment of a method of determining an influence score for a user of one or more social-networking websites is implemented. The system 1 comprises a server 2, a first user device 4, a first user 6, a second user device 8, a second user 10, a plurality of further user devices 12, and a plurality of further users 14.

Each of the first, second, and further user devices 4, 8, 12 may be any appropriate electronic communications devices, for example, computers (e.g., tablet computers or “smartphones”) or other information appliances. The first user 6 is a user of the first user device 4. Likewise, the second user 10 is a user of the second user device 8. Likewise, each of the further users 14 is a user of a respective further user device 12. The user devices 4, 8, 12 are coupled to the server 2 over a network 16 such as the Internet. Thus, the server 2 may serve to interact with any or all of the users 6, 10, 14 over an interactive electronic medium (i.e., a respective user device 4, 8, 12).

The users 6, 10, 14 are users, or members, of one or more social-networking services (e.g., Google+™, Twitter™, Facebook™, etc.). The users 6, 10, 14 may belong to the same social graphs or networks that are provided by the one or more social-networking services. These social graphs may be directed or undirected. These social graphs may be explicit (i.e., individuals within the social graph may express links to other individuals) or implicit (i.e., links between individuals within a social graph may be based on, for example, trust, respect, positive or negative opinion, etc., expressed between individuals, e.g., directly or by interactions with a shared object or media item). In this embodiment, the users 6, 10, 14 are people. However, in other embodiments the users 6, 10, 14 may be other entities (e.g., web pages, blogs, companies, groups of people, etc.).

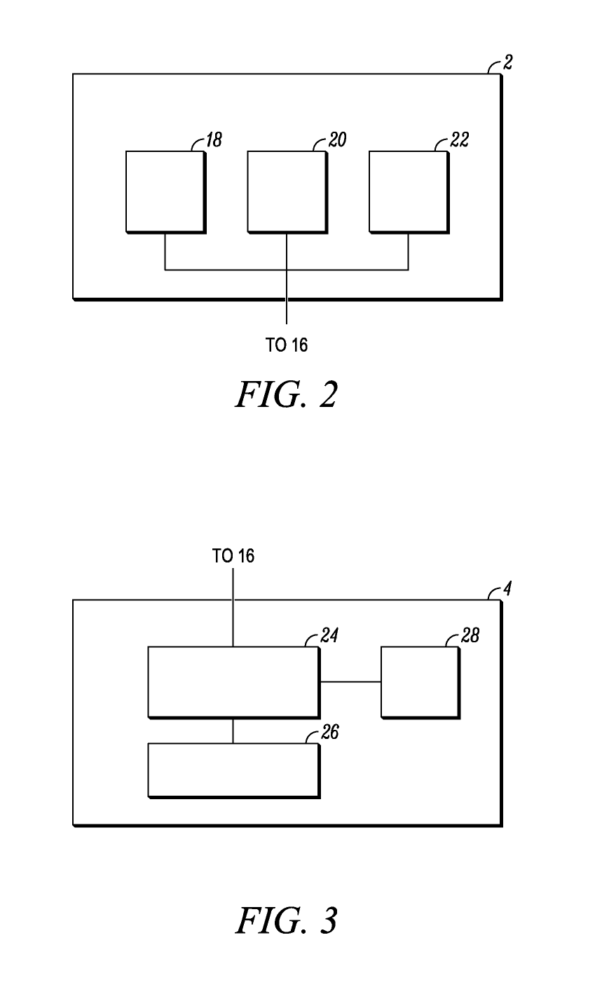

FIG. 2 is a schematic illustration (not to scale) of the server 2 of the example system 1. The server 2 may comprise a selection module 18, a server processor 20, and a server storage module 22. The selection module 18, the server processor 20, and the server storage module 22 may be coupled together such that information may be sent from any of those modules to any other of those modules. Furthermore, the selection module 18, the server processor 20, and the server storage module 22 may be connected (e.g., by a wired or wireless data-link) to the network 16 such that information may be sent (via the network 16) between any of those modules and an entity that is remote from the server 2. In other embodiments, some or all of one or more of the modules shown in FIG. 2 (i.e., one or more of the selection module 18, the server processor 20, and the server storage module 22) may be part of a different module (i.e., other than the server 2), e.g., a user device.

The selection module 18 is configured to select and retrieve data accessible via the network 16. This data may, for example, be stored on any of the user devices 4, 8, 12 or on one or more further servers (not shown). The functionality of the selection module 18 is described in more detail below with reference to FIG. 4.

The server processor 20 is configured to process data received by it as described in more detail below with reference to FIG. 4.

The server storage module 22 is configured to store data received by it as described in more detail below with reference to FIG. 4.

FIG. 3 is a schematic illustration (not to scale) of the first user device 4 of the example system 1. The first user device 4 comprises a device processor 24, a user interface 26, and a device storage module 28. The device processor 24, the user interface 26, and the device storage module 28 may be coupled together such that information may be sent from any of those modules to any other of those modules (e.g., information stored in the device storage module 28 may be retrieved from the storage module 28 by the device processor 24 and sent, e.g., for display to the first user 6, to the user interface 26). Furthermore, the device processor 24 may be connected (e.g., by a wired or wireless data-link) to the network 16 such that information may be sent (via the network 16) between the device processor 24 and an entity that is remote from the first user device 4.

The device processor 24 is configured to process data received by it as described in more detail below with reference to FIG. 4.

The user interface 26 is configured to display information to the first user 6. Also, the first user 6 may input information into the first user device 4 (e.g., for processing by the device processor 24 or for transmitting, via the network 16, to an entity remote from the first user device 4) using the user interface 26. The user interface 26 may, for example, be a touch-screen display or may comprise a display, a keyboard, and a mouse.

The device storage module 28 is configured to store data received by it as described in more detail below with reference to FIG. 4.

FIG. 4 is a process flow chart showing certain steps of a process of determining an influence score for a user of one or more social-networking websites, as implemented in the example system 1. In this embodiment, an influence score for the second user 10 is determined.

At step s2, the selection module 18 selects and retrieves data relating to the second user's interaction with the social-networking website of the second user 10 (hereinafter referred to as “social-networking data” for the second user 10). The social-networking data for the second user 10 may include, but are not limited to, data points from Twitter™, such as following count (i.e., the number of Twitter™ users the second user 10 is “following”), follower count (i.e., the number of Twitter™ users “following” the second user 10), re-tweets (i.e., the number of the second user's Twitter™ posts that have been re-posted by other Twitter™ users), “favorites” (i.e., the number of the second user's posts that have been selected as a “favorite” by other Twitter™ users or the number of posts that the second user 10 has selected as a “favorite”), replies (i.e., the number of posts from the second user 10 that have attracted a directed response from other users or the number of posts where the second user 10 has directed a response to others), context (i.e., the location from which the second user 10 posted updates, keywords, and “hashtags” employed by the second user 10, applications authorized by the second user 10 to post updates on his behalf, etc.), the number of dormant Twitter™ accounts following the second user 10, data indicative of how influential the Twitter™ users that re-post the second user's Twitter™ posts are, a number of “unique mentions” of the second user 10, etc. The social-networking data for the second user 10 may also include data points from Facebook™, such as the number of comments on the Facebook™ profile of the second user 10, the number of “likes” accumulated by the Facebook™ status updates of the second user 10, the number of Facebook™ friends of the second user 10, etc. The social-networking data for the second user 10 may also include data points from Google+™, such as the number and identity of “video chats” initiated (or joined) by the second user 10, the number of content items posted by the second user 10, the number or identity of explicit groups (circles) established by or joined by the second user 10, etc. The social-networking data for the second user 10 may also include profile information for the user (e.g., gender, location, employment, interests) or data points from any other appropriate source.

The selection module 18 may retrieve the social-networking data for the second user 10 by downloading that data, via the network 16, from one or more further servers (not shown).

At step s4, the social-networking data for the second user 10 are sent from the selection module 18 to the server processor 20.

At step s6, the server processor 20 computes, i.e., calculates, a score value (or an “influence score”) using the received social-networking data for the second user 10. This computed score value is indicative of the relative influence that the second user 10 has online (i.e., the influence of the second user 10 relative to other online users). In other words, the influence score for the second user 10 indicates the degree to which the second user's view or opinions influence other users. The terminology “influence score” of a user is used herein to refer to any value based on that user's social-networking activity, i.e., activity within the social networks provided by the social-networking services. Influence scores may be used to rank users of a social-networking service. An influence score for a user may be determined using any or all of the following data: information relating to the user's social-networking profile, information relating to a subject or topic the user has expressed an interest in, information relating to an activity performed in the social network by the user, data relating to the membership of the user in a group, data relating to other members of the user's social networks, data relating to the number of members of the user's social networks, etc.

The influence score value for the second user 10 may be computed using any appropriate algorithm. For example, an algorithm used by Klout™, Peerindex™, or an algorithm used to compute a Kred™ Influence Measurement (or “Kred”) may be used.

The influence score value for the second user 10 computed at step s6 is hereinafter referred to as the “public influence score” for the second user 10.

At step s7, the server processor 20 stores the public influence score for the second user 10 in the server storage module 22. The public influence score for the second user 10 that is stored in the server storage module 22 may be made available for use by entities remote from the server 2.

At step s8, the computed public influence score for the second user 10 is sent from the server 2 to the first user device 4, e.g., via the network 16. This may, for example, be performed as a result of the server 2 receiving an instruction to send the public influence score for the second user 10 to the first user device 4. For example, the first user device 4 may instruct the server 2 to send the public influence score for the second user 10 to first user device 4. Alternatively, the first user device 4 may retrieve, from the server 2, the public influence score for the second user 10.

At step s10, the public influence score for the second user 10 is displayed, to the first user 6, using the user interface 26.

Thus, steps s2 through s10 comprise a process of, for the second user 10, computing (and displaying to the first user 6) an influence score based on all available social-networking data for the second user 10.

In other embodiments, the public influence score for the second user 10 may be retrieved (e.g., via the network 16) from a score repository (not shown). In other words, in other embodiments a public influence score may be calculated automatically by a third party, e.g., a conventional ranking system such as Klout™ (i.e., as opposed to performing steps s2 through s8 as described above). This public influence score may then be retrieved from the third party.

At step s12, the first user 6 may specify a subset of the social-networking data for the second user 10.

The subset of the social-networking data for the second user 10 may, for example, be specified to include only data relating to only topics or subjects that are of interest to the first user 6 (e.g., sports, politics, etc.). These topics of interest may be specified by using keywords or categories etc. In other words, the subset may be specified by removing data relating to subjects that are not of interest to the first user 6. Also, the subset of the social-networking data for the second user 10 may, for example, be specified to only include data from a certain source (e.g., Google+™, Twitter™, or Facebook™, etc.). In other words, the subset may be specified by removing data from certain other sources. Also, the subset of the social-networking website data for the second user 10 may, for example, be specified to only include recent data (e.g., data generated by the second user 10 recently, e.g., in the last week). In other words, the subset may be specified by removing older data (e.g., data generated over a week ago). Also, the subset of the social-networking data for the second user 10 may, for example, be specified to only include specific locations (e.g., data generated by the second user 10 in the locale of the first user 6 or in the location of an event specified by the first user 6).

The subset of the social-networking data for the second user 10 may be specified by the first user 6 in any appropriate way. For example, a list of topics, data sources, locations, or time periods may be presented (e.g., on the user interface 26) to the first user 6. The first user 6 may then select, from the displayed list, those data elements he wishes to include in the subset of the social-networking data for the second user 10. In other words, the subset of the social-networking data for the second user 10 may be selected manually using data filters. Also for example, the subset of the social-networking data for the second user 10 may be specified automatically, e.g., by the device processor 24 using a predefined policy provided by the first user 6. The selection process may also be iterative. For example, the first user 6 may select query criteria (location, topics) using a first selection menu and be presented with a list of matching results from the server 2. The first user 6 may then further select from the displayed list only a subset of data items for one criterion (e.g., location). Also for example, the subset of the social-networking data for the second user 10 may be specified or pre-defined by the first user 6 (or by a different party). Thus, the first user 6 (or the different party) may provide that dataset directly. This tends to allow the first user 6 to introduce data about the second user 10 from face-to-face conversations or from other sources (e.g., email).

At step s14, the specification of the subset of the social-networking data for the second user 10 is sent from the first user device 4 to the server 2, e.g., via the network 16.

At step s16, the server processor 20 computes, i.e., calculates, a new score value (or a new influence score) using the received specification of the subset of the social-networking data for the second user 10. This computed new score value is indicative of the relative influence that second user 10 has online with respect to the criteria used to specify the subset of the social-networking data for the second user 10. For example, if (at step s12) the subset of the social-networking data for the second user 10 was specified by selecting only social-networking data that related to a certain topic, then the new score value computed at step s16 would be indicative of how influential the second user 10 is online with respect to that certain topic.

The new influence score value for the second user 10 may be computed using any appropriate algorithm. For example, the new influence score may be computed using the same algorithm as used at step s6.

The new influence score value for the second user 10 computed at step s16 is hereinafter referred to as a “personalized influence score.” The new influence score value for the second user 10 computed at step s16 is the first user's personalized influence score for the second user 10.

The terminology “personalized influence score” is used because that score value has been calculated using only data that relate to topics, subjects, time periods, sources, etc., that are of interest to the first user 6. Thus, the personalized influence score determined at step s16 has been “personalized” by the first user 6. An influence score for the second user 10 that has been personalized by a further user 14 may be different from the influence score for the second user 10 that has been personalized by the first user 6 because the further user 14 may specify a different subset of the social-networking data for the second user 10 with which to calculate a score value (i.e., the topics, subjects, time periods, sources, etc., that are of interest to the further user 14 may be different from those that are of interest to the first user 6).

At step s17, the server processor 20 stores the influence score for the second user 10 that has been personalized by the first user 6 in the server storage module 22. The personalized influence score for the second user 10 that is stored in the server storage module 22 may be made available for use by entities remote from the server 2. Also, the personalized influence score for the second user 10 that is stored in the server storage module 22 may be stored alongside data indicating that it was produced according to the specification of the first user 6. The criteria according to which, and details of the computation algorithm with which, the personalized influence score for the second user 10 was computed may also be stored.

At step s18, the influence score for the second user 10 that has been personalized by the first user 6 is sent from the server 2 to the first user device 4, e.g., via the network 16. This may, for example, be performed in the same way as step s8.

At step s20, the influence score for the second user 10 that has been personalized by the first user 6 is displayed to the first user 6, using the user interface 26. The public influence score for the second user 10, and the selection criteria used for computing the personalized score, may also be displayed to the first user 6 (e.g., alongside the personalized influence score for the second user 10) for context.

At step s22, the first user 6 may (e.g., if the first user 6 desires) further modify or adjust the personalized influence score for the second user 10. This modified or adjusted personalized influence score for the second user 10 is hereinafter referred to as “the adjusted influence score for the second user 10.” This adjustment of the score may, for example, be performed manually (by the first user 6 increasing or decreasing the value) or by the first user 6 re-specifying the subset of the social-networking data for the second user 10 that is used to calculate the influence score for the second user 10 that has been personalized by the first user 6. In other words, the first user 6 may change his personalized influence score for the second user 10. The first user 6 may do this, for example, to take into account information that may not be available to the server 2, e.g., off-line conversations between the first user 6 and the second user 10 or opinions expressed by the second user 10 in non-electronic media. Also, the first user 6 may, for example, adjust the personalized influence score for the second user 10 depending upon a personalized score for a further user 14 (e.g., further users 14 that may have been selected based on some criteria and whose personalized influence score may have been determined based on the same criteria as the influence score for the second user 10 that has been personalized by the first user 6). For example, the first user 6 may have a higher regard for the views, on a certain topic, of the second user 10 compared to the views, on that certain topic, of a further user 14. The first user 6 may manually adjust the personalized score (for that certain subject) for the second user 10 to be higher than that of a further user 14. Also, the first user 6 may, for example, adjust his personalized influence score for the second user 10 depending upon the identity of the second user 10. For example, the second user 10 may be a family member of the first user 6, and so the first user 6 may manually adjust his personalized score for the second user 10 to be higher to take into account the greater level of influence of the second user 10.

At step s23, the adjusted influence score for the second user 10 may be sent from the first user device 4 to the server 2, e.g., via the network 16. It may also be accompanied by the selection criteria or by additional user-specified criteria (e.g., new context attributes specified by the first user 6 for the second user 10 during the score modification step) associated with that adjusted score.

At step s24, the adjusted influence score for the second user 10 is stored in the server storage module 22 of the server 2. Also, the adjusted influence score for the second user 10 may be stored in the device storage module 28 of the first user device 4. The adjusted influence score for the second user 10 stored at step s24 may overwrite the unadjusted influence score for the second user 10 that was personalized by the first user 6 and stored at step s17.

The adjusted influence score for the second user 10 that is stored in the server storage module 22 may be made available for use by entities remote from the server 2. Also, the adjusted influence score for the second user 10 that is stored in the server storage module 22 may be stored alongside data indicating that it was produced according to the specification of the first user 6. The criteria according to which, and details of the computation algorithm with which, the adjusted influence score for the second user 10 was computed may also be stored.

The influence score for the second user 10 that was personalized by the first user 6 (and any adjustments made to the value by the first user 6) may, for example, be used in the same way as a conventional influence value.

At step s26, the value of the influence score for the second user 10 that was personalized by the first user 6 (and any adjustments made to the value by the first user 6) may be notified to one or more parties or entities. The parties that are notified of the value of the influence score for the second user 10 that was personalized by the first user 6 or changes to the value of that score (e.g., those made by the first user 6) may be subscribers to a service that notifies them of such values and changes.

Parties or entities that may be notified of the value of the influence score for the second user 10 that was personalized by the first user 6, or changes to that value, may include, but are not limited to: (i) the user whose score has been computed or changed, (ii) a system that re-calculates a public influence score for individuals, e.g., based on a plurality of private or personalized influence scores, and (iii) a system that calculates personalized scores for individuals.

For example, the second user 10 may be notified of the value of the influence score for the second user 10 that was personalized by the first user 6 and also the criteria on which that score value was calculated. This may, for example, be used by the second user 10 to assess how influential (e.g., with respect to certain topics, or with respect to certain social-networking websites, or during certain time periods) the first user 6 deems him to be. Also, for example, if, at some point in time, the first user 6 increases or decreases his personalized influence score for the second user 10, then the second user 10 may be informed of this increase or decrease.

Parties or entities that may be notified of the value of the influence score for the second user 10 that was personalized by the first user 6, or changes to that value, may take any appropriate action based on the received information.

Thus, a method of determining influence scores for a user of one or more social-networking websites is provided.

The above described system and method tends to utilize direct input from the producer of the social-networking data (i.e., the user being “scored,” e.g., the second user 10 in the above described embodiment) or a consumer of some or all of that social-networking data (i.e., the user who is “personalizing” the score value, e.g., the first user 6 in the above described embodiment).

The personalized influence score provided by the above described system and method advantageously tends to be subjective, i.e., the personalized influence score tends to depend on the opinion or views of the party personalizing the score. This tends to produce a more useful and meaningful score value for the party personalizing the score value (e.g., the first user 6). Also, this advantageously tends to be useful for the party that the personalized score describes (e.g., the second user 10), as it enables him to see how he is perceived by particular individuals.

The above described method advantageously allows a user to incorporate offline information (e.g., private conversations, etc.) when determining influence scores. This tends to be in contrast to conventional processes that typically only use available online data. This advantageously allows, for example, a user to account for locality in the determination of influence scores. For example, a user may trust his local mechanic's opinion over that of an unknown mechanic and may wish his influence score for the local mechanic to be higher than that of the unknown mechanic. Also, this advantageously allows, for example, a user to account for topic priority in the determination of influence scores. For example, a user may regard expertise in a first topic to be more important than expertise in another topic and may wish his influence score for parties to reflect this opinion. Also, this advantageously allows, for example, a user to account for his personal relationships in the determination of influence scores. For example, a user may have a relative who is not particularly active on a social-networking website and may wish his influence score for that relative to be higher to reflect the fact that the user values the opinions, etc., of that relative more highly than those of a stranger.

In other words, subjectivity biases of a user tend to be advantageously accommodated for by giving that user control over the selection filters and policy that may be applied to the data used in the computation of an influence score. Thus, a user can, in effect, select a subset of content items or people that reflect personal views or opinions, and use those selected items to derive a more appropriate influence score for a different user. Thus for example, a user can ask for the influence score to be computed only using social-graph members within his locality. Also, observability biases of a machine-based system may be overcome by allowing a user to manually adjust the influence score computed by a machine-based system.

A manually adjusted score value may be flagged as “manually adjusted.” If the data that was used for the computation of the influence score change, the influence score may be recomputed. The user may be alerted about the re-computation of the score value and, for example, asked if he wants to impose the same manual adjustment to that new score, or if he wants to impose a different manual adjustment, or just use the new score.

The above described personalized influence scores tend to be advantageously multi-faceted. In other words, a user may view influence scores of a person based upon certain criteria (i.e., with respect to certain topics, locations, social filters, etc.). This tends to be in contrast to conventional influence scores which are typical of only a single score value that is indicative of a user's overall influence and provides no context for the criteria under which that score value was obtained. This multi-faceting tends to be provided by storing both personalized influence scores and the criteria, policies, and adjustment used to create those scores.

Conventional machine-based algorithms that are used to determine conventional influence scores may generate a score value for a user that is, e.g., between 1 and 100. These values may be computed over a large population, e.g., millions of people. An average user tends to have a relatively small number of people in his social graph (e.g., a couple of hundred people). Thus, large clusters of the user's social graph may be awarded the same influence score value. The above described systems and methods advantageously enable a user to produce score values that have a higher degree of discrimination. These score values tend to be more useful for that user.

The personalized score values advantageously tend to reduce errors in commission. In other words, the personalized score values advantageously tend to reduce occurrences of irrelevant or inappropriate content or sources being prioritized for a user. Furthermore, the personalized score values advantageously tend to reduce errors in omission. In other words, the personalized score values advantageously tend to reduce occurrences of relevant or appropriate content or sources not being prioritized for a user. This tends to provide better a better user experience.

The above described system and method advantageously tend to allow a user to create personalized score values that take into account his individual biases and relationships (e.g., that may not be observable by a machine-based system), his individual priorities, interests, or topic weights. Furthermore, a user can create personalized score values despite sparseness of his individual social graph.

The above described system and method advantageously tend to incorporate manual intervention (of a user) to allow personalized influence scores to be created. This manual intervention may be explicitly provided, e.g., via a user interface, or may be implicitly provided, e.g., via user-created rules or policies.

In other embodiments, a user may generate or store a plurality of different influence scores for a different user. For example, a user may compute a “base” score and one or more “derivative” scores for another user. A base score may be a public influence score for the other person (e.g., a score determined as described above with reference to step s6 of FIG. 4) with an optional manual adjustment of the score by the user. In other words, a base score may be an influence score determined using no user-defined filters or policies. A derivative score may be an influence score determined in the same way as the base score (i.e., using the same algorithm and using the same manual adjustment) but with one or more user-defined filters or policies applied. Hence, the user can have multiple derivative influence scores for the same other user. Each derivative score may be associated with a different category or context for ranking.

In other embodiments, a user may be assisted or guided during the personalization of an influence score. For example, a “Score Assist Wizard” may be provided (e.g., by a software application running on a user device). Such assistance may be in the form of visual aids.

For example, using the above described method, the first user 6 generates a first personalized score value for the second user 10. This first personalized score value is computed based on a first user-defined policy. Personalized influence scores for the further users 14 computed based on the same first user-defined policy may then be displayed to the first user 6. The first user 6 may use this information to adjust the policy or to adjust the personalized influence score for the second user 10 directly. The first user 6 may also use the information to adjust (or to create) a personalized influence score for the further users 14, in order to maintain a desired distribution or hierarchy of scores across the relevant users. Also, the first user 6 may use this information to adjust the personalized influence scores for one or more of the further users 14 directly.

In other embodiments, a user may compute (and use, store, etc.) a personalized score for a different user based on the personalized scores for that other user that have been determined by one or more different users. For example, the first user 6 may calculate a personalized influence score for the second user 10 as being a weighted combination of the further users' personalized scores for the second user 10. Influence scores computed in this way may, for example, be filtered or manually adjusted as described above with reference to steps s12 through s26 of FIG. 4.

In some embodiments, the influence score is a directly estimated objective measure of influence (e.g., estimated using a social graph). In some embodiments, the techniques described herein include a social graph of individuals on the Internet, such as shown in FIG. 1, in which the individuals represent natural or legal persons, and the documents represent natural or legal persons or other entities such as computational processes, documents, data files, or any form of product or service or information of any means or form for which a representation has been made within the computer network within this system.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method of determining, for use by a first party, an influence score for a second party, the second party being different from the first party, the second party being a user of one or more social-networking services, the second party being a member of one or more social networks provided by one or more of the social-networking services, the influence score for the second party being indicative of the relative influence that the second party exerts within one or more social networks of which the second party is a member, the method comprising:
acquiring, by one or more processors, a set of one or more criteria, the criteria having been specified by the first party;
acquiring, by the one or more processors, a dataset, the dataset comprising data that relate to one or more topics selected from the group consisting of:
actions performed by the second party in relation to one or more of the social networks provided by one or more of the social-networking services;
actions performed by a third party, the third party being a member of one or more of the social networks of which the second party is a member, the third party being different from the second party, an action performed by the third party having been performed in response to, or in relation to, an action performed by the second party;
properties of one or more of the social networks of which the second party is a member; and
profile information for the second party that has been provided to one or more of the social-networking services;
selecting from the dataset, by the one or more processors, data that are in accordance with the one or more criteria; and
determining, by the one or more processors, some function of the selected data, thereby providing the influence score for the second party.

2. A method according to claim 1 wherein the dataset comprises data that relate to one or more topics selected from the group consisting of: a social-networking profile of the second party, a subject or topic the second party has communicated about with another user of one or more of the social-networking services, the membership of the second party in a social-networking group, and the number of members of one or more of the social networks of which the second party is a member.

3. A method according to claim 1 wherein the one or more criteria specified by the first party comprise one or more criteria selected from the group consisting of: criteria specifying that only data relating to a certain topic should be selected, criteria specifying that only data relating to certain data source should be selected, criteria specifying that only data pre-defined by the first party should be selected, criteria specifying that only data pre-defined by the third party should be selected, and criteria specifying that only data relating to a certain time period should be selected.

4. A method according to claim 1 wherein acquiring the set of one or more criteria comprises:
displaying, to the first party, using a display operatively coupled to the one or more processors, for selection by the first party, one or more criteria options; and
in response to the first party selecting one or more of the displayed criteria options, including in the set of one or more criteria, those criteria corresponding to the criteria options selected by the first party.

5. A method according to claim 1 further comprising:
acquiring, by the one or more processors, an initial influence score for a fourth party, the fourth party being different from the second party, the fourth party being a user of one or more social-networking services, the fourth party being a member of one or more social networks provided by one or more of the social-networking services, the influence score for the fourth party being indicative of the relative influence that the fourth party exerts within one or more social networks of which the fourth party is a member;
displaying to the first party, using a display operatively coupled to the one or more processors, the influence score for the second party;
displaying to the first party, using the display, the influence score for the fourth party;
comparing, by the first party, the influence score for the second party with the influence score for a fourth party; and
based on the comparison, modifying, by the first party, either the influence score for the second party or the influence score for the fourth party.

6. A method according to claim 1 further comprising storing, using storage means operatively coupled to the one or more processors, the determined influence score for the second party and information relating to the one or more criteria.

7. A method of determining, for use by a first party, an influence score for a second party, the second party being different from the first party, the second party being a user of one or more social-networking services, the second party being a member of one or more social networks provided by one or more of the social-networking services, the influence score for the second party being indicative of the relative influence that the second party exerts within one or more social networks of which the second party is a member, the method comprising:
acquiring, by one or more processors, an initial influence score for the second party;
acquiring, by the one or more processors, an initial influence score for a third party, the third party being different from the second party, the third party being a user of one or more social-networking services, the third party being a member of one or more social networks provided by one or more of the social-networking services, the influence score for the third party being indicative of the relative influence that the third party exerts within one or more social networks of which the third party is a member;
displaying to the first party, using a display operatively coupled to the one or more processors, the initial influence score for the second party;
displaying to the first party, using the display, the initial influence score for the third party;
comparing, by the first party, the initial influence score for the second party with the initial influence score for the third party; and
based on the comparison, modifying, by the first party, the initial influence score for the second party, thereby providing the influence score for the second party.

8. A method according to claim 7 further comprising storing, using storage means operatively coupled to the one or more processors, the influence score for the second party and information relating to the modification performed on the initial influence score.

9. A method according to claim 7 wherein acquiring an initial influence score for the second party comprises determining the initial influence score for the second party.

10. A method according to claim 9 wherein determining the initial influence score for the second party comprises:
acquiring a plurality of further influence scores for the second party; and
calculating some function of the further influence scores, thereby providing the initial influence score for the second party.

11. A method according to claim 10 wherein calculating some function of the further influence scores comprises calculating a weighted sum of the further influence scores.

12. A method according to claim 11 wherein weights used in the weighted sum calculation have been specified by the first user.

13. A method according to claim 9 wherein determining the initial influence score for the second party comprises:
acquiring a dataset, the dataset comprising data that relate to one or more topics selected from the group consisting of:
actions performed by the second party in relation to one or more of the social networks provided by one or more of the social-networking services;
actions performed by a fourth party, the fourth party being a member of one or more of the social networks of which the second party is a member, the fourth party being different from the second party, an action performed by the fourth party having been performed in response to, or in relation to, actions performed by the second party;
properties of one or more of the social networks of which the second party is a member; and
profile information for the second party provided to one or more of the social-networking services; and
calculating some function of the data within the dataset, thereby providing the initial influence score for the second party.

14. A method according to claim 13 wherein the dataset comprises data that relate to one or more topics selected from the group consisting of: a social-networking profile of the second party, a subject or topic the second party has communicated about with another user of one or more of the social-networking services, the membership of the second party in a social-networking group, and the number of members of one or more of the social networks of which the second party is a member.

15. A method according to claim 9 wherein determining the initial influence score for the second party comprises:
acquiring a set of one or more criteria, the criteria having been specified by the first party;
acquiring a dataset, the dataset comprising data that relates to one or more topics selected from the group consisting of:
actions performed by the second party in relation to one or more of the social networks provided by one or more of the social-networking services;
actions performed by a fourth party, the fourth party being a member of one or more of the social networks of which the second party is a member, the fourth party being different from the second party, an action performed by the fourth party having been performed in response to, or in relation to, actions performed by the second party;
properties of one or more of the social networks of which the second party is a member; and
profile information for the second party provided to one or more of the social-networking services;
selecting from the dataset data that are in accordance with the one or more criteria; and
calculating some function of the selected data, thereby providing the initial influence score for the second party.

16. A method of determining, for use by a first party, an influence score for a second party, the second party being different from the first party, the second party being a user of one or more social-networking services, the second party being a member of one or more social networks provided by one or more of the social-networking services, the influence score for the second party being indicative of the relative influence that the second party exerts within one or more social networks of which the second party is a member, the method comprising:
acquiring, by one or more processors, a plurality of initial influence scores for the second party; and
calculating, by the one or more processors, some function of the initial influence scores, thereby providing the influence score for the second party;
wherein each of the respective initial influence scores for the second party have been determined by:
acquiring, by the one or more processors, a respective set of one or more criteria, the criteria having been specified by a respective further party;
acquiring, by the one or more processors, a dataset, the dataset comprising data that relate to one or more topics selected from the group consisting of:
actions performed by the second party in relation to one or more of the social networks provided by one or more of the social-networking services;
actions performed by a third party, the third party being a member of one or more of the social networks of which the second party is a member, the third party being different from the second party, an action performed by the third party having been performed in response to, or in relation to, actions performed by the second party;
properties of one or more of the social networks of which the second party is a member; and
profile information for the second party provided to one or more of the social-networking services;
selecting from the dataset, by the one or more processors, data that are in accordance with the one or more criteria of the respective set; and
determining, by the one or more processors, some function of the selected data, thereby providing the respective initial influence score for the second party.

17. A method according to claim 16:
wherein calculating some function of the further influence scores comprises calculating a weighted sum of the further influence scores; and
wherein weights used in the weighted sum calculation have been specified by the first user.

18. Apparatus for determining, for use by a first party, an influence score for a second party, the second party being different from the first party, the second party being a user of one or more social-networking services, the second party being a member of one or more social networks provided by one or more of the social-networking services, the influence score for the second party being indicative of the relative influence that the second party exerts within one or more social networks of which the second party is a member, the apparatus comprising one or more processors configured to:
acquire a set of one or more criteria, the criteria having been specified by a first party;
acquire a dataset, the dataset comprising data that relate to one or more topics selected from the group consisting of:
actions performed by the second party in relation to one or more of the social networks provided by one or more of the social-networking services;
actions performed by a third party, the third party being a member of one or more of the social networks of which the second party is a member, the third party being different from the second party, an action performed by the third party having been performed in response to, or in relation to, actions performed by the second party;
properties of one or more of the social networks of which the second party is a member; and
profile information for the second party provided to one or more of the social-networking services;
select, from the dataset, data that are in accordance with the one or more criteria; and
determine some function of the selected data, thereby providing the influence score for the second party.

19. Apparatus for determining, for use by a first party, an influence score for a second party, the second party being different from the first party, the second party being a user of one or more social-networking services, the second party being a member of one or more social networks provided by one or more of the social-networking services, the influence score for the second party being indicative of the relative influence that the second party exerts within one or more social networks of which the second party is a member, the apparatus comprising:
one or more processors arranged to:
acquire an initial influence score for the second party; and
acquire an influence score for a third party, the third party being different from the second party, the third party being a user of one or more social-networking services, the third party being a member of one or more social networks provided by one or more of the social-networking services, the influence score for the second party third being indicative of the relative influence that the third party exerts within one or more social networks of which the third party is a member; and
a display operatively coupled to the one or more processors, the display arranged to:
display, to the first party, the initial influence score for the second party and the influence score for the third party, thereby enabling the first party to compare the initial influence score for the second party with the influence score for the third party;
wherein the one or more processors are further arranged to:
in response to receiving an input from the first part, the input being dependent on the first party's comparison of the initial influence score for the second party with the influence score for the third party, modify the initial influence score for the second party, thereby providing the influence score for a second party.

20. Apparatus for determining, for use by a first party, an influence score for a second party, the second party being different from the first party, the second party being a user of one or more social-networking services, the second party being a member of one or more social networks provided by one or more of the social-networking services, the influence score for the second party being indicative of the relative influence that the second party exerts within one or more social networks of which the second party is a member, the apparatus comprising one or more processors configured to:
acquire a plurality of initial influence scores for the second party; and
calculate some function of the initial influence scores, thereby providing the influence score for the second party;
wherein each of the respective initial influence scores for the second party have been determined by:
acquiring, by one or more processors, a respective set of one or more criteria, the criteria having been specified by a respective further party;
acquiring, by the one or more processors, a dataset, the dataset comprising data that relate to one or more topics selected from the group consisting of:
actions performed by the second party in relation to one or more of the social networks provided by one or more of the social-networking services;
actions performed by a third party, the third party being a member of one or more of the social networks of which the second party is a member, the third party being different from the second party, an action performed by the third party having been performed in response to, or in relation to, actions performed by the second party;
properties of one or more of the social networks of which the second party is a member; and
profile information for the second party provided to one or more of the social-networking services;
selecting from the dataset, by the one or more processors, data that are in accordance with the one or more criteria of the respective set; and
determining, by the one or more processors, some function of the selected data, thereby providing the respective initial influence score for the second party.
